(19) United States
(12) Patent Application Publication
(10) Pub. No.: US 2024/0193233 A1
(43) Pub. Date: Jun. 13, 2024

(54) PORTING DIGITAL ENTITLEMENTS ACROSS APPLICATIONS

(71) Applicant: Meta Platforms Technologies, LLC, Menlo Park, CA (US)

(72) Inventors: Vaishali Parekh, San Francisco, CA (US); Mina Maher Shawky Abouseif, Clyde Hill, WA (US); Hansmeet Sethi, Seattle, WA (US); Jimmy Xu, Hayward, CA (US); Hardeep Rajpal, Los Angeles, CA (US); Sheldon Lee, San Francisco, CA (US)

(21) Appl. No.: 18/532,560

(22) Filed: Dec. 7, 2023

Related U.S. Application Data
(60) Provisional application No. 63/430,759, filed on Dec. 7, 2022.

(51) Int. Cl. G06F 21/10

(52) U.S. Cl. CPC G06F 21/1084; G06F 21/1078; G06F 21/1085

(57) ABSTRACT

Methods, systems, and storage media for managing digital entitlements are disclosed. Exemplary implementations may: determine at least one digital entitlement; generate a digital backpack; select a third party platform; generate an application program interface (API) call associated with the at least one digital entitlement to a third party application; and store the at least one entitlement in the digital backpack.

### CROSS REFERENCE TO RELATED APPLICATIONS

This present application claims the benefit of priority under 35 U.S.C. § 119(e) to U.S. Provisional Application No. 63/430,759, filed Dec. 7, 2022, the disclosure of which is hereby incorporated by reference in its entirety for all purposes.

### TECHNICAL FIELD

The present disclosure generally relates to managing digital entitlements, and more particularly to porting digital entitlements across applications.

### BACKGROUND

The field of digital entitlements has seen significant advancements in recent years, with various platforms and applications offering users access to digital goods and content. However, there is a lack of a centralized and portable system that allows users to easily manage and transfer their digital entitlements across different applications and platforms. This has resulted in a fragmented user experience and limited interoperability between different digital ecosystems. porting digital entitlements across applications

### BRIEF SUMMARY

The subject disclosure provides for systems and methods for managing digital entitlements. A user is enabled to seamlessly port their acquired digital entitlements, such as avatars, subscriptions, and in-game currencies, across various applications and platforms without the need for redundant acquisition processes. For example, the digital entitlements can be consolidated into a digital backpack, which can be recognized and accessed by different platforms through application program interface (API) calls, thereby enhancing the user's experience by creating a more integrated and rewarding digital environment.

One aspect of the present disclosure relates to a method for managing digital entitlements. The method may include determining at least one digital entitlement. The method may include generating a digital backpack. The digital backpack may include an API. The API is configured to store the at least one digital entitlement. The method may include selecting a third party platform. The method may include generating an API call associated with the at least one digital entitlement to a third party application. The method may include storing the at least one entitlement in the digital backpack.

Another aspect of the present disclosure relates to a system configured for managing digital entitlements. The system may include one or more hardware processors configured by machine-readable instructions. The processor(s) may be configured to determine at least one digital entitlement. The processor(s) may be configured to generate a digital backpack. The processor(s) may be configured to select a third party platform. The processor(s) may be configured to generate an API call associated with the at least one digital entitlement to a third party application. The processor(s) may be configured to store the at least one entitlement in the digital backpack.

Yet another aspect of the present disclosure relates to a non-transient computer-readable storage medium having instructions embodied thereon, the instructions being executable by one or more processors to perform a method for managing digital entitlements. The method may include determining at least one digital entitlement. The method may include generating a digital backpack. The digital backpack may include an API. The API is configured to store the at least one digital entitlement. The method may include selecting a third party platform. The method may include generating an API call associated with the at least one digital entitlement to a third party application. The method may include storing the at least one entitlement in the digital backpack.

Still another aspect of the present disclosure relates to a system configured for managing digital entitlements. The system may include means for determining at least one digital entitlement. The system may include means for generating a digital backpack. The digital backpack may include an API. The API is configured to store the at least one digital entitlement. The system may include means for selecting a third party platform. The system may include means for generating an API call associated with the at least one digital entitlement to a third party application. The system may include means for storing the at least one entitlement in the digital backpack.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 is a block diagram illustrating an overview of an environment in which some implementations of the disclosed technology can operate.

FIG. 2 illustrates an example relationship between a main account and various information about user identity, user payment methods, and digital entitlements owned by a user, in accordance with one or more implementations.

FIG. 3 illustrates an example relationship between the main account and a user's digital entitlements, in accordance with one or more implementations.

FIG. 4 illustrates an example relationship between multiple accounts and the user's digital entitlements where there is interoperability through account linking, in accordance with one or more implementations.

FIG. 5 illustrates an example relationship between the main account and a given third-party platform, in accordance with one or more implementations.

FIG. 6 illustrates an example user interface for managing and organizing digital entitlements, in accordance with one or more implementations.

FIG. 7 illustrates a system configured for managing digital entitlements, in accordance with one or more implementations.

FIG. 8 illustrates an example flow diagram for managing digital entitlements, according to certain aspects of the disclosure.

FIG. 9 is a block diagram illustrating an example computer system (e.g., representing both client and server) with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

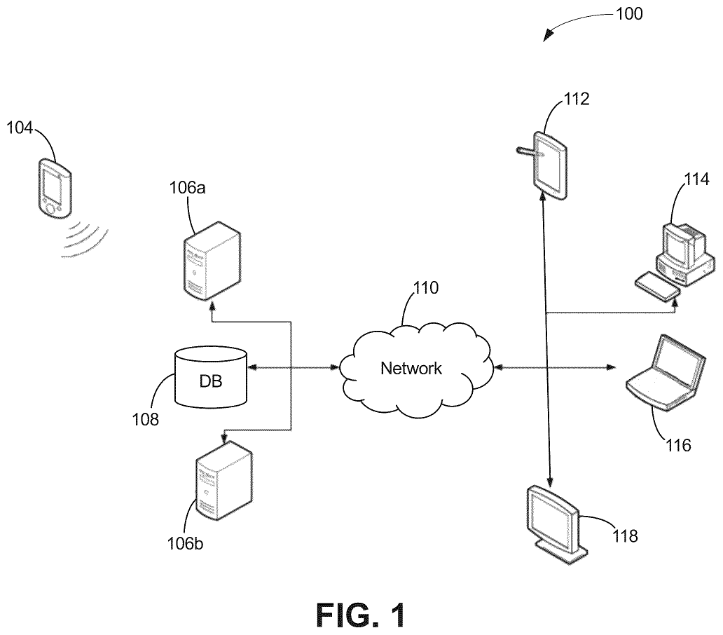

FIG. 1 is a block diagram illustrating an overview of an environment 100 in which some implementations of the disclosed technology can operate. The environment 100 can include one or more client computing devices, mobile device 104, tablet 112, personal computer 114, laptop 116, desktop 118, and/or the like. Client devices may communicate wirelessly via the network 110. The client computing devices can operate in a networked environment using logical connections through network 110 to one or more remote computers, such as server computing devices.

In some implementations, the environment 100 may include a server such as an edge server which receives client requests and coordinates fulfillment of those requests through other servers. The server may include the server computing devices 106a-106b, which may logically form a single server. Alternatively, the server computing devices 106a-106b may each be a distributed computing environment encompassing multiple computing devices located at the same or at geographically disparate physical locations. The client computing devices and server computing devices 106a-106b can each act as a server or client to other server/client device(s). The server computing devices 106a-106b can connect to a database 108 or can comprise its own memory. Each server computing devices 106a-106b can correspond to a group of servers, and each of these servers can share a database 108 or can have their own database 108. The database 108 may logically form a single unit or may be part of a distributed computing environment encompassing multiple computing devices that are located within their corresponding server, located at the same, or located at geographically disparate physical locations.

The network 110 can be a local area network (LAN), a wide area network (WAN), a mesh network, a hybrid network, or other wired or wireless networks. The network 110 may be the Internet or some other public or private network. Client computing devices can be connected to network 110 through a network interface, such as by wired or wireless communication. The connections can be any kind of local, wide area, wired, or wireless network, including the network 110 or a separate public or private network. In some implementations, the server computing devices 106a-106b can be used to support different platforms and/or applications implemented via the network 110.

The existing systems for managing digital entitlements may suffer from several limitations. Users may often face challenges in accessing and using their entitlements across different applications and platforms. There may be no standardized way to transfer entitlements from one platform to another, leading to a lack of integration and a disjointed user experience. Additionally, the lack of a centralized system for managing entitlements may make it difficult for users to keep track of their digital assets and rights.

The subject disclosure provides for systems and methods for managing digital entitlements. A user is enabled to seamlessly port their acquired digital entitlements, such as avatars, subscriptions, and in-game currencies, across various applications and platforms without the need for redundant acquisition processes. For example, the digital entitlements can be consolidated into a digital backpack, which can be recognized and accessed by different platforms through API calls, thereby enhancing the user's experience by creating a more integrated and rewarding digital environment.

Implementations described herein address the aforementioned problems and other problems by providing a unified and portable system for managing digital entitlements. The system includes a digital backpack that serves as a centralized repository for all of the user's digital entitlements. Through an API, users may access and manage their entitlements, allowing for easy transfer and utilization across various platforms. This ensures that users have full control over their digital assets and can enjoy a consistent experience across different applications. The system enhances interoperability and usability, providing users with a streamlined and rewarding experience in the digital ecosystem. Some implementations also include a wallet, which allows users to manage their financial identity and payment instruments within the same unified system. By integrating the backpack and wallet, users have a comprehensive solution for managing both their digital entitlements and financial transactions. Overall, these implementations improve the user experience by simplifying the management and transfer of digital assets, promoting integration between different platforms, and providing users with greater control and convenience.

When seeking full access of digital entitlements, a user may be limited in their ability to access and use the entitlements they may have acquired in various applications and platforms. These digital entitlements can include passwords; currency in videogames that can be transferred; gift cards, subscriptions avatars and the associated attributes. Previously, there was no way to port these entitlements. The ability to port these acquired items can yield a more integrated and rewarding experience as a user traverses applications.

There is a unified layer on the backend server to manage entitlements. In one aspect, the unified layer can be related to the platforms associated with a main platform. In a further aspect, additional applications and programs can use the digital entitlements by using an additional API to integrate with the other programs. The backpack can be used to integrate the acquired digital items across other platforms.

The digital entitlements can be included in a backpack. In another embodiment, the digital backpack can function as a digital wallet that can be ported across social media platforms and applications. The digital backpack can comprise all of the digital entitlements associated with a user's identity, such as avatars, subscriptions, gift cards, passwords, and even elements that can be on the blockchain. When a user is attempting to transport their backpack to other platforms, the system can generate an API call. The API call can comprise both right and read access privileges to the backpack. When the user attempts to access the third party platform, the API call can be sent to the third party platform wherein the platform can then recognize the digital backpack. In a further aspect, the user may acquire additional digital entitlements that were a part of their experience on a third party platform. For example, if the user was attempting to use a program such as Roblox® or Spotify®, attributes that can be associated with the avatar or additional music permission rights can be added to the backpack. The original API call to the third party platforms can recognize the read and write access to the backpack, allowing the digital backpack to receive and store the entitlements acquired from the third party platform. Further, the user can then transport the backpack or just simply have access to the backpack's contents.

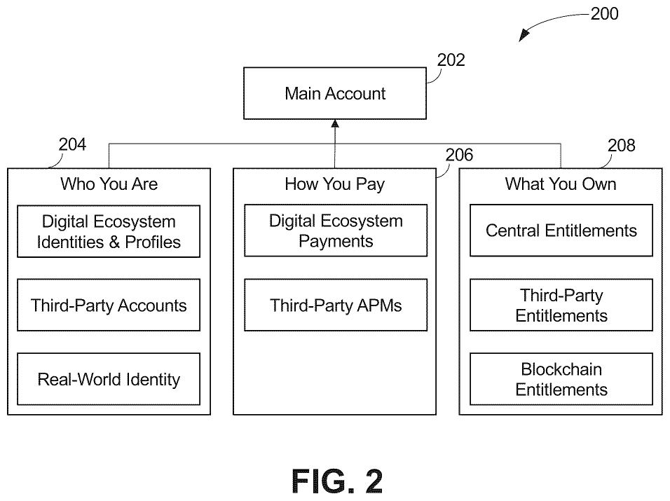

FIG. 2 illustrates an example relationship 200 between a main account 202 and various information about user identity, user payment methods, and digital entitlements owned by a user, in accordance with one or more implementations. The main account 202 may serve as a primary interface for a user within a digital ecosystem. The main account 202 may be linked to several components that define the user's interaction within the ecosystem, which may include a user identity component 204, a payment methods component 206, a digital entitlement component 208, and/or other components.

The user identity component 204 may be linked to the main account 202, representing the various digital identities the user may possess across different platforms and services. This may include social media profiles, avatars, or any other form of digital representation that the user has created or acquired. The user identity component 204 may ensure that the user's persona is consistent and recognizable across the digital ecosystem.

The payment methods component 206 may be linked to the main account 202. The digital entitlement component 208 may aggregate all the payment instruments associated with the user, such as credit cards, bank accounts, digital wallets, and potentially cryptocurrency holdings. The payment methods component 206 may facilitate transactions within the ecosystem, allowing the user to purchase digital goods, services, or content seamlessly across different platforms and applications.

The digital entitlement component 208 may be linked with the main account 202. The digital entitlement component 208 may represent the collection of digital assets, rights, and content that the user owns or has access to. The digital entitlement component 208 may include items such as in-game currencies, virtual goods, subscriptions, licenses for software or media, and any other form of entitlement that grants the user access to digital content or services.

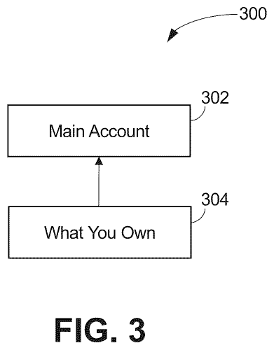

FIG. 3 illustrates an example relationship 300 between a main account 302 and a user's digital entitlements 304, in accordance with one or more implementations. The main account 302 may be the same as or similar to the main account 202 in FIG. 2. The user's digital entitlements may include one or more of centralized entitlements, third-party entitlements, blockchain entitlements, and/or other entitlements. Centralized entitlements may include those for which the main platform itself is the entitlement store, indicating that the platform maintains the record of truth for these assets. These may encompass digital goods and content that the user has acquired, either through purchase or as free grants, from products and services within the digital ecosystem.

Third-party entitlements may represent the user's rights and access to benefits from external service providers, such as music streaming services, online subscriptions, or gaming platforms. These entitlements may be linked to the main account 302 through mechanisms like account linking, allowing for a seamless experience where the user's digital goods and services from third-party providers are accessible through the main platform.

Blockchain entitlements include digital assets that are associated with the blockchain, such as non-fungible tokens (NFTs) or cryptocurrency holdings. These assets may be stored in third-party crypto wallets or, in future implementations, custodied by the main platform itself. The main account 302 may have a cached version of these blockchain entitlements within its databases, establishing a connection to the blockchain while centralizing the user's digital asset portfolio.

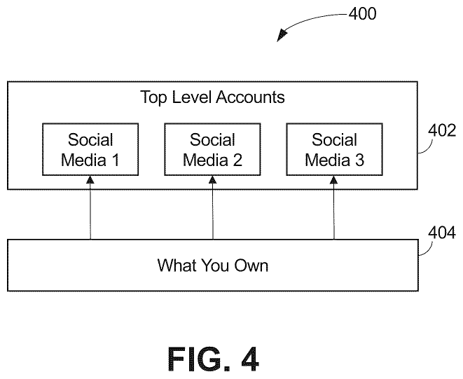

FIG. 4 illustrates an example relationship 400 between multiple accounts 402 and the user's digital entitlements 404 where there is interoperability through account linking, in accordance with one or more implementations. The user's main account (e.g., the main account 202 in FIG. 2) may serve as a gateway to a variety of top-level accounts across the digital ecosystem. These top-level accounts may be represented as individual nodes that are linked to the user's main account, allowing for a seamless and unified experience across different platforms and services. The user's digital entitlements 404 may be the same as or similar to the user's digital entitlements 304 in FIG. 3.

Interoperability through account linking may be facilitated where the user's entitlements are accessible across the variety of top-level accounts across the digital ecosystem due to the connections established between the top-level accounts and the main account. This interoperability may ensure that entitlements remain consistent and portable, regardless of the platform or service where they were acquired. A unified API layer may aggregate and expose the user's entitlements across centralized, third-party, blockchain, and/or other sources. This service layer may enable product teams to integrate entitlement checks into their applications, allowing users to buy, consume, reference, or use their digital goods and content across the digital ecosystem.

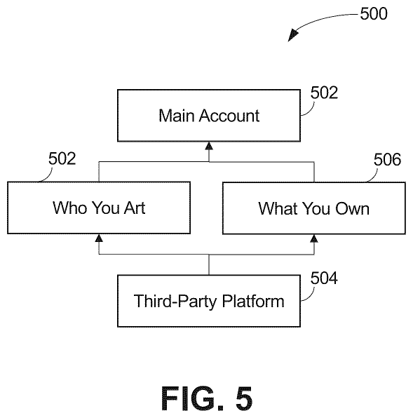

FIG. 5 illustrates an example relationship 500 between a main account 502 and a given third-party platform 504, in accordance with one or more implementations. The main account 502 may include a central node that is associated with various user-specific elements such as identity and entitlements. The main account 502 may have a direct link to the user's digital backpack 506 and the user's identity 508.

The digital backpack 506 may serve as a repository for the user's digital entitlements and potentially other digital assets. The digital backpack 506 may be connected to the main account through a secure authentication process, ensuring that only the authorized user can access and manage the contents of the backpack. The digital backpack 506 may interface with the third-party platform 504 through a set of APIs. These APIs may facilitate the transfer of digital entitlements between the digital backpack 506 and the third-party platform 504, allowing for a seamless user experience across different services and applications.

The third-party platform 504 may include an external entity that can interact with the main account 502 and the digital backpack 506. The interaction may be governed by permissions and access controls, which may include a set of rules or protocols that determine how and when the third-party platform can access the digital entitlements stored in the backpack. The third-party platform 504 may contribute additional digital entitlements to the user's digital backpack 506, which can then be used or accessed across other platforms and services.

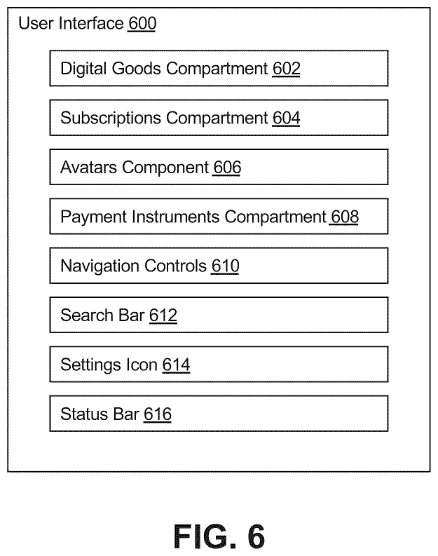

FIG. 6 illustrates an example user interface 600 for managing and organizing digital entitlements, in accordance with one or more implementations. The user interface 600 may be presented as a part of a digital backpack system that aggregates a user's digital entitlements across multiple platforms and applications, providing a centralized view of what the user owns in the digital ecosystem. The user interface 600 may be divided into several compartments, each representing different categories of entitlements such as digital goods, subscriptions, avatars, and payment instruments. Users may interact with these compartments to view and manage their respective contents.

A digital goods compartment 602 may display icons or thumbnails of items such as in-game currencies, virtual clothing, or other digital assets that the user has acquired across various platforms. Selecting an item within this compartment may reveal additional information about the item, such as its origin, current value, and applicable usage rights.

A subscriptions compartment 604 may lists the various services the user is subscribed to, such as music streaming services, premium application features, or online memberships. This section may provide details like subscription status, renewal dates, and quick access to manage these subscriptions.

An avatars compartment 606 may showcases the user's digital personas across different social media platforms and games. This section may allow the user to customize their avatars, view associated attributes, and/or transfer certain characteristics between platforms if supported by the underlying systems.

A payment instruments compartment 608 may integrate the user's financial tools such as credit cards, digital wallets, and cryptocurrency holdings. This section may facilitate seamless transactions across the digital platforms by allowing the user to select preferred payment methods for purchases or to add new payment instruments.

Navigation controls 610 may allow the user to switch between different views of the backpack, such as a detailed list view, a grid view, or a categorized view. Additionally, there may be a search bar 612 to quickly locate specific entitlements within the backpack.

The user interface 600 may include a settings icon 614 providing access to privacy and security settings, allowing users to manage who can view their backpack contents or to set up multi-factor authentication for added security.

A status bar 616 may displays the user's identity verification status, indicating whether the user's real-world identity has been confirmed, which is used for certain transactions or entitlements that require a verified identity.

The disclosed system(s) address a problem in traditional digital entitlement management techniques tied to computer technology, namely, the technical problem of users being unable to seamlessly access and utilize their acquired digital entitlements such as passwords, subscriptions, and in-game currencies across various platforms and applications. The disclosed system solves this technical problem by providing a solution also rooted in computer technology, namely, by providing for porting digital entitlements across applications. The disclosed subject technology further provides improvements to the functioning of the computer itself because it improves processing and efficiency in managing digital entitlements.

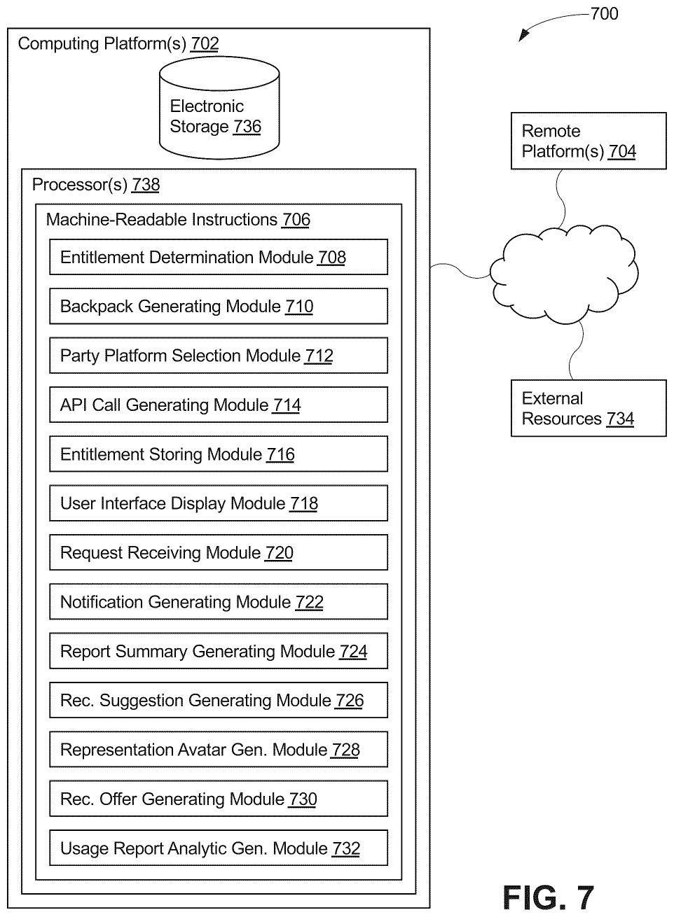

FIG. 7 illustrates a system 700 configured for managing digital entitlements, according to certain aspects of the disclosure. In some implementations, system 700 may include one or more computing platforms 702. Computing platform(s) 702 may be configured to communicate with one or more remote platforms 704 according to a client/server architecture, a peer-to-peer architecture, and/or other architectures. Remote platform(s) 704 may be configured to communicate with other remote platforms via computing platform(s) 702 and/or according to a client/server architecture, a peer-to-peer architecture, and/or other architectures. Users may access system 700 via remote platform(s) 704.

Computing platform(s) 702 may be configured by machine-readable instructions 706. Machine-readable instructions 706 may include one or more instruction modules. The instruction modules may include computer program modules. The instruction modules may include one or more of entitlement determination module 708, backpack generating module 710, party platform selection module 712, API call generating module 714, entitlement storing module 716, user interface display module 718, request receiving module 720, notification generating module 722, report summary generating module 724, recommendation suggestion generating module 726, representation avatar generating module 728, recommendation offer generating module 730, usage report analytic generating module 732, and/or other instruction modules.

Entitlement determination module 708 may be configured to determine at least one digital entitlement. Entitlement determination module 708 may be configured to determine a secondary digital entitlement. Determining may include verifying at least one permission associated with the secondary digital entitlement. The secondary digital entitlement may be acquired in a third party application.

Backpack generating module 710 may be configured to generate a digital backpack. The API may include write access to the digital backpack. The digital backpack may include a plurality of digital entitlements. The digital backpack may further include a user interface for managing and organizing the digital entitlements. The digital backpack may be encrypted to ensure the security and privacy of the digital entitlements.

By way of non-limiting example, the digital backpack may include a history log that records the acquisition, usage, and transfer of the digital entitlements. The digital backpack may include a search function that allows the user to easily locate and access specific digital entitlements. The digital backpack may include a sharing feature that allows the user to share selected digital entitlements with other users. The digital backpack may include a backup and restore function to prevent loss of the digital entitlements. The digital backpack may include a synchronization feature that synchronizes the digital entitlements across multiple devices and platforms. The digital backpack may include a rating or review system for the digital entitlements.

The digital backpack may include a social sharing feature that allows the user to share their digital entitlements on social media platforms. The digital backpack may include a collaboration feature that allows multiple users to access and manage the digital entitlements together. The digital backpack may include a gamification feature that rewards the user for acquiring and using the digital entitlements. The digital backpack may include a recommendation engine that suggests new digital entitlements based on the user's preferences and usage history. The digital backpack may include an application program interface and wherein the API is configured to store the at least one digital entitlement.

Party platform selection module 712 may be configured to select a third party platform. API call generating module 714 may be configured to generate an API call associated with the at least one digital entitlement to a third party application. The API call may include an attribute of the at least one entitlement. The API call may include read access to the digital backpack. The API call can be specified of a subset of digital entitlements from the plurality of digital entitlements. The API call may include authentication information to verify the users access to the digital entitlements.

Entitlement storing module 716 may be configured to store the at least one entitlement in the digital backpack. Entitlement storing module 716 may be configured to store the secondary digital entitlement in the digital backpack. User interface display module 718 may be configured to display a user interface including attributes associated with the digital backpack. Request receiving module 720 may be configured to receive a request from the user to transfer the digital entitlements to another user or platform. Notification generating module 722 may be configured to generate a notification to the user when new digital entitlements are added to the backpack.

Report summary generating module 724 may be configured to generate a report or summary of the digital entitlements stored in the backpack. Recommendation suggestion generating module 726 may be configured to generate a recommendation or suggestion to the user based on the digital entitlements stored in the backpack. Representation avatar generating module 728 may be configured to generate a virtual representation or avatar of the user within the digital backpack. The avatar can interact with the digital entitlements. Recommendation offer generating module 730 may be configured to generate a personalized recommendation or offer based on the digital entitlements stored in the backpack. Usage report analytic generating module 732 may be configured to generate a usage report or analytics based on the digital entitlements stored in the backpack.

In some implementations, computing platform(s) 702, remote platform(s) 704, and/or external resources 734 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 702, remote platform(s) 704, and/or external resources 734 may be operatively linked via some other communication media.

A given remote platform 704 may include one or more processors configured to execute computer program modules. The computer program modules may be configured to enable an expert or user associated with the given remote platform 704 to interface with system 700 and/or external resources 734, and/or provide other functionality attributed herein to remote platform(s) 704. By way of non-limiting example, a given remote platform 704 and/or a given computing platform 702 may include one or more of a server, a desktop computer, a laptop computer, a handheld computer, a tablet computing platform, a NetBook, a Smartphone, a gaming console, and/or other computing platforms.

External resources 734 may include sources of information outside of system 700, external entities participating with system 700, and/or other resources. In some implementations, some or all of the functionality attributed herein to external resources 734 may be provided by resources included in system 700.

Computing platform(s) 702 may include electronic storage 736, one or more processors 738, and/or other components. Computing platform(s) 702 may include communication lines, or ports to enable the exchange of information with a network and/or other computing platforms. Illustration of computing platform(s) 702 in FIG. 7 is not intended to be limiting. Computing platform(s) 702 may include a plurality of hardware, software, and/or firmware components operating together to provide the functionality attributed herein to computing platform(s) 702. For example, computing platform(s) 702 may be implemented by a cloud of computing platforms operating together as computing platform(s) 702.

Electronic storage 736 may comprise non-transitory storage media that electronically stores information. The electronic storage media of electronic storage 736 may include one or both of system storage that is provided integrally (i.e., substantially non-removable) with computing platform(s) 702 and/or removable storage that is removably connectable to computing platform(s) 702 via, for example, a port (e.g., a USB port, a firewire port, etc.) or a drive (e.g., a disk drive, etc.). Electronic storage 736 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 736 may include one or more virtual storage resources (e.g., cloud storage, a virtual private network, and/or other virtual storage resources). Electronic storage 736 may store software algorithms, information determined by processor(s) 738, information received from computing platform(s) 702, information received from remote platform(s) 704, and/or other information that enables computing platform(s) 702 to function as described herein.

Processor(s) 738 may be configured to provide information processing capabilities in computing platform(s) 702. As such, processor(s) 738 may include one or more of a digital processor, an analog processor, a digital circuit designed to process information, an analog circuit designed to process information, a state machine, and/or other mechanisms for electronically processing information. Although processor(s) 738 is shown in FIG. 7 as a single entity, this is for illustrative purposes only. In some implementations, processor(s) 738 may include a plurality of processing units. These processing units may be physically located within the same device, or processor(s) 738 may represent processing functionality of a plurality of devices operating in coordination. Processor(s) 738 may be configured to execute modules 708, 710, 712, 714, 716, 718, 720, 722, 724, 726, 728, 730, and/or 732, and/or other modules. Processor(s) 738 may be configured to execute modules 708, 710, 712, 714, 716, 718, 720, 722, 724, 726, 728, 730, and/or 732, and/or other modules by software; hardware; firmware; some combination of software, hardware, and/or firmware; and/or other mechanisms for configuring processing capabilities on processor(s) 738. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 708, 710, 712, 714, 716, 718, 720, 722, 724, 726, 728, 730, and/or 732 are illustrated in FIG. 7 as being implemented within a single processing unit, in implementations in which processor(s) 738 includes multiple processing units, one or more of modules 708, 710, 712, 714, 716, 718, 720, 722, 724, 726, 728, 730, and/or 732 may be implemented remotely from the other modules. The description of the functionality provided by the different modules 708, 710, 712, 714, 716, 718, 720, 722, 724, 726, 728, 730, and/or 732 described below is for illustrative purposes, and is not intended to be limiting, as any of modules 708, 710, 712, 714, 716, 718, 720, 722, 724, 726, 728, 730, and/or 732 may provide more or less functionality than is described. For example, one or more of modules 708, 710, 712, 714, 716, 718, 720, 722, 724, 726, 728, 730, and/or 732 may be eliminated, and some or all of its functionality may be provided by other ones of modules 708, 710, 712, 714, 716, 718, 720, 722, 724, 726, 728, 730, and/or 732. As another example, processor(s) 738 may be configured to execute one or more additional modules that may perform some or all of the functionality attributed below to one of modules 708, 710, 712, 714, 716, 718, 720, 722, 724, 726, 728, 730, and/or 732.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

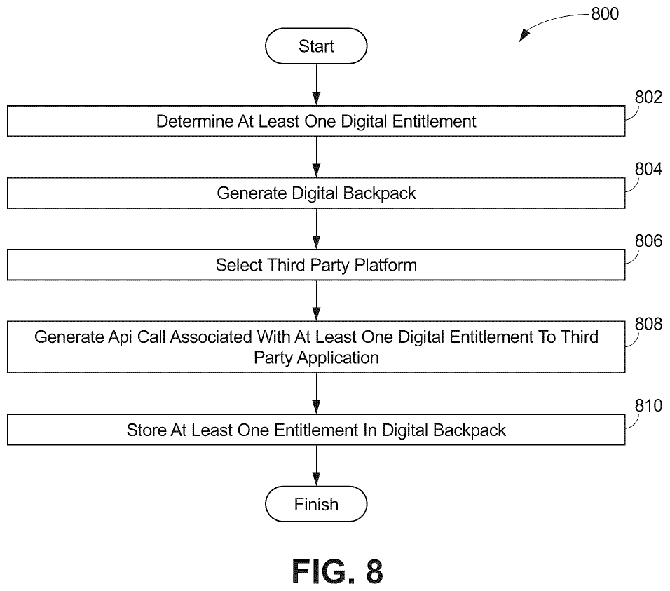

FIG. 8 illustrates an example flow diagram (e.g., process 800) for managing digital entitlements, according to certain aspects of the disclosure. For explanatory purposes, the example process 800 is described herein with reference to FIGS. 1-7. Further for explanatory purposes, the steps of the example process 800 are described herein as occurring in serial, or linearly. However, multiple instances of the example process 800 may occur in parallel. For purposes of explanation of the subject technology, the process 800 will be discussed in reference to FIGS. 1-7.

At step 802, the process 800 may include determining at least one digital entitlement. At step 804, the process 800 may include generating a digital backpack. The digital backpack may include an application program interface and wherein the API is configured to store the at least one digital entitlement. At step 806, the process 800 may include selecting a third party platform. At step 808, the process 800 may include generating an API call associated with the at least one digital entitlement to a third party application. At step 810, the process 800 may include storing the at least one entitlement in the digital backpack.

For example, as described above in relation to FIG. 7, at step 802, the process 800 may include determining at least one digital entitlement, through entitlement determination module 708. At step 804, the process 800 may include generating a digital backpack, through backpack generating module 710. The digital backpack may include an application program interface and wherein the API is configured to store the at least one digital entitlement. At step 806, the process 800 may include selecting a third party platform, through party platform selection module 712. At step 808, the process 800 may include generating an API call associated with the at least one digital entitlement to a third party application, through API call generating module 714. At step 810, the process 800 may include storing the at least one entitlement in the digital backpack, through entitlement storing module 716.

According to an aspect, the API call comprises an attribute of the at least one entitlement.

According to an aspect, the API call comprises read access to the digital backpack.

According to an aspect, the process 800 may include determining a secondary digital entitlement, wherein the secondary digital entitlement is acquired in a third party application.

According to an aspect, determining comprises verifying at least one permission associated with the secondary digital entitlement.

According to an aspect, the process 800 may include storing the secondary digital entitlement in the digital backpack.

According to an aspect, the API comprises write access to the digital backpack.

According to an aspect, the digital backpack comprises a plurality of digital entitlements, wherein the API call can be specified of a subset of digital entitlements from the plurality of digital entitlements.

According to an aspect, the process 800 may include displaying a user interface comprising attributes associated with the digital backpack.

According to an aspect, the digital backpack further comprises a user interface for managing and organizing the digital entitlements.

According to an aspect, the API call includes authentication information to verify the user's access to the digital entitlements.

According to an aspect, the digital backpack is encrypted to ensure the security and privacy of the digital entitlements.

According to an aspect, the process 800 may include receiving a request from the user to transfer the digital entitlements to another user or platform.

According to an aspect, the digital backpack includes a history log that records the acquisition, usage, and transfer of the digital entitlements.

According to an aspect, the digital backpack includes a search function that allows the user to easily locate and access specific digital entitlements.

According to an aspect, the process 800 may include generating a notification to the user when new digital entitlements are added to the backpack.

According to an aspect, the digital backpack includes a sharing feature that allows the user to share selected digital entitlements with other users.

According to an aspect, the process 800 may include generating a report or summary of the digital entitlements stored in the backpack.

According to an aspect, the digital backpack includes a backup and restore function to prevent loss of the digital entitlements.

According to an aspect, the digital backpack includes a synchronization feature that synchronizes the digital entitlements across multiple devices and platforms.

According to an aspect, the process 800 may include generating a recommendation or suggestion to the user based on the digital entitlements stored in the backpack.

According to an aspect, the digital backpack includes a rating or review system for the digital entitlements.

According to an aspect, the process 800 may include generating a virtual representation or avatar of the user within the digital backpack, wherein the avatar can interact with the digital entitlements.

According to an aspect, the digital backpack includes a social sharing feature that allows the user to share their digital entitlements on social media platforms.

According to an aspect, the process 800 may include generating a personalized recommendation or offer based on the digital entitlements stored in the backpack.

According to an aspect, the digital backpack includes a collaboration feature that allows multiple users to access and manage the digital entitlements together.

According to an aspect, the process 800 may include generating a usage report or analytics based on the digital entitlements stored in the backpack.

According to an aspect, the digital backpack includes a gamification feature that rewards the user for acquiring and using the digital entitlements.

According to an aspect, the digital backpack includes a recommendation engine that suggests new digital entitlements based on the user's preferences and usage history.

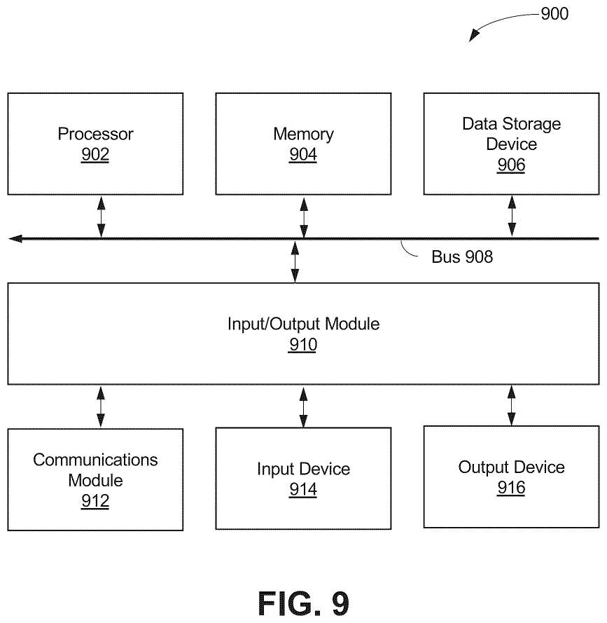

FIG. 9 is a block diagram illustrating an exemplary computer system 900 with which aspects of the subject technology can be implemented. In certain aspects, the computer system 900 may be implemented using hardware or a combination of software and hardware, either in a dedicated server, integrated into another entity, or distributed across multiple entities.

Computer system 900 (e.g., server and/or client) includes a bus 908 or other communication mechanism for communicating information, and a processor 902 coupled with bus 908 for processing information. By way of example, the computer system 900 may be implemented with one or more processors 902. Processor 902 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 900 can include, in addition to hardware, code that creates an execution environment for the computer program in question, e.g., code that constitutes processor firmware, a protocol stack, a database management system, an operating system, or a combination of one or more of them stored in an included memory 904, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 908 for storing information and instructions to be executed by processor 902. The processor 902 and the memory 904 can be supplemented by, or incorporated in, special purpose logic circuitry.

The instructions may be stored in the memory 904 and implemented in one or more computer program products, i.e., one or more modules of computer program instructions encoded on a computer-readable medium for execution by, or to control the operation of, the computer system 900, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 904 may also be used for storing temporary variable or other intermediate information during execution of instructions to be executed by processor 902.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

Computer system 900 further includes a data storage device 906 such as a magnetic disk or optical disk, coupled to bus 908 for storing information and instructions. Computer system 900 may be coupled via input/output module 910 to various devices. The input/output module 910 can be any input/output module. Exemplary input/output modules 910 include data ports such as USB ports. The input/output module 910 is configured to connect to a communications module 912. Exemplary communications modules 912 include networking interface cards, such as Ethernet cards and modems. In certain aspects, the input/output module 910 is configured to connect to a plurality of devices, such as an input device 914 and/or an output device 916. Exemplary input devices 914 include a keyboard and a pointing device, e.g., a mouse or a trackball, by which a user can provide input to the computer system 900. Other kinds of input devices 914 can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 916 include display devices such as an LCD (liquid crystal display) monitor, for displaying information to the user.

According to one aspect of the present disclosure, the above-described gaming systems can be implemented using a computer system 900 in response to processor 902 executing one or more sequences of one or more instructions contained in memory 904. Such instructions may be read into memory 904 from another machine-readable medium, such as data storage device 906. Execution of the sequences of instructions contained in the main memory 904 causes processor 902 to perform the process steps described herein. One or more processors in a multi-processing arrangement may also be employed to execute the sequences of instructions contained in memory 904. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 900 can include clients and servers. A client and server are generally remote from each other and typically interact through a communication network. The relationship of client and server arises by virtue of computer programs running on the respective computers and having a client-server relationship to each other. Computer system 900 can be, for example, and without limitation, a desktop computer, laptop computer, or tablet computer. Computer system 900 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 902 for execution. Such a medium may take many forms, including, but not limited to, non-volatile media, volatile media, and transmission media. Non-volatile media include, for example, optical or magnetic disks, such as data storage device 906. Volatile media include dynamic memory, such as memory 904. Transmission media include coaxial cables, copper wire, and fiber optics, including the wires that comprise bus 908. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

As the user computing system 900 reads game data and provides a game, information may be read from the game data and stored in a memory device, such as the memory 904. Additionally, data from the memory 904 servers accessed via a network the bus 908, or the data storage 906 may be read and loaded into the memory 904. Although data is described as being found in the memory 904, it will be understood that data does not have to be stored in the memory 904 and may be stored in other memory accessible to the processor 902 or distributed among several media, such as the data storage 906.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

What is claimed is:

1. A computer-implemented method for managing digital entitlements, the method comprising:
determining at least one digital entitlement;
generating a digital backpack, wherein the digital backpack comprises an application program interface (API), and wherein the API is configured to store the at least one digital entitlement;
selecting a third party platform;
generating an API call associated with the at least one digital entitlement to a third party application; and
storing the at least one entitlement in the digital backpack.

2. The method of claim 1, wherein the API call comprises an attribute of the at least one entitlement.

3. The method of claim 1, wherein the API call comprises read access to the digital backpack.

4. The method of claim 1, further comprising determining a secondary digital entitlement, wherein the secondary digital entitlement is acquired in a third party application.

5. The method of claim 1, wherein determining comprises verifying at least one permission associated with the secondary digital entitlement.

6. The method of claim 1, further comprising storing the secondary digital entitlement in the digital backpack.

7. The method of claim 1, wherein the API comprises write access to the digital backpack.

8. The method of claim 1, wherein the digital backpack comprises a plurality of digital entitlements, wherein the API call can be specified of a subset of digital entitlements from the plurality of digital entitlements.

9. The method of claim 1, further comprising displaying a user interface comprising attributes associated with the digital backpack.

10. The method of claim 1, wherein the digital backpack further comprises a user interface for managing and organizing the digital entitlements.

11. A system configured for managing digital entitlements, the system comprising:
one or more hardware processors configured by machine-readable instructions to:
determine at least one digital entitlement;
generate a digital backpack, wherein the digital backpack comprises an application program interface (API), and wherein the API is configured to store the at least one digital entitlement;
select a third party platform;
generate an API call associated with the at least one digital entitlement to a third party application; and
store the at least one entitlement in the digital backpack.

12. The system of claim 11, wherein the API call includes authentication information to verify the users access to the digital entitlements.

13. The system of claim 11, wherein the digital backpack is encrypted to ensure the security and privacy of the digital entitlements.

14. The system of claim 11, wherein the one or more hardware processors are further configured by machine-readable instructions to receive a request from the user to transfer the digital entitlements to another user or platform.

15. The system of claim 11, wherein the digital backpack includes a history log that records the acquisition, usage, and transfer of the digital entitlements.

16. The system of claim 11, wherein the digital backpack includes a search function that allows the user to easily locate and access specific digital entitlements.

17. The system of claim 11, wherein the one or more hardware processors are further configured by machine-readable instructions to generate a notification to the user when new digital entitlements are added to the backpack.

18. The system of claim 11, wherein the digital backpack includes a sharing feature that allows the user to share selected digital entitlements with other users.

19. The system of claim 11, wherein the one or more hardware processors are further configured by machine-readable instructions to generate a report or summary of the digital entitlements stored in the backpack.

20. A non-transient computer-readable storage medium having instructions embodied thereon, the instructions being executable by one or more processors to perform a method for managing digital entitlements, the method comprising:
determining at least one digital entitlement;
generating a digital backpack, wherein the digital backpack comprises an application program interface (API), and wherein the API is configured to store the at least one digital entitlement;
selecting a third party platform;
generating an API call associated with the at least one digital entitlement to a third party application; and
storing the at least one entitlement in the digital backpack.
